(19) United States
(12) Patent Application Publication
(10) Pub. No.: US 2026/0024038 A1
(43) Pub. Date: Jan. 22, 2026

(54) SYSTEMS AND METHODS FOR GENERATING INDUSTRY-SPECIFIC SOLUTIONS USING COLLABORATIVE ARTIFICIAL INTELLIGENCE (AI) AGENTS

(71) Applicant: ACCENTURE GLOBAL SOLUTIONS LIMITED, Dublin 4 (IE)

(72) Inventors: Aarti IYER, Bangalore (IN); Romesh Viswanath, Hyderabad (IN); Gaurav Sanjay Gade, Pune (IN); Prateek Shrivastav, Pune (IN); Sanjeev Narsipur, Bangalore (IN); Raghavan Tinniyam Iyer, Bangalore (IN)

(73) Assignee: ACCENTURE GLOBAL SOLUTIONS LIMITED, Dublin 4 (IE)

(21) Appl. No.: 19/347,215

(22) Filed: Oct. 1, 2025

(30) Foreign Application Priority Data
Apr. 10, 2024 (IN) 202441075218

(51) Int. Cl. G06Q 10/0631; G06F 40/30; G06Q 10/0637

(52) U.S. Cl. CPC G06Q 10/06316; G06F 40/30; G06Q 10/063112; G06Q 10/0637

(57) ABSTRACT

Systems and methods for generating industry-specific solutions using collaborative Artificial Intelligence (AI) agents are disclosed. In an aspect, input data corresponding to an industry-specific problem is received. A goal context for the industry-specific problem is then identified. Further, an industry-specific process workflow corresponding to the industry-specific problem is selected based on the goal context. Furthermore, an agentic context, historical intelligence data, group dynamics data for agent compatibility, appropriate agent character data, and historical user feedback data corresponding to the industry-specific workflow are retrieved. Moreover, AI agents and agent compatibility rules to execute user goals are selected and the rules are assigned to each AI agent. An agentic process workflow for the industry-specific problem is then generated. A candidate solution is then generated by executing the generated agentic process workflow. The candidate solution, agentic process workflow and agent compatibility rules are then outputted on a user interface of a user device.

### CROSS-REFERENCE TO RELATED APPLICATION(S)

This application claims priority under 35 USC § 119 (a) to an Indian Provisional Application No. 202441075218, filed on Oct. 4, 2024, the entire content of which is hereby incorporated by reference in the entirety for all purposes.

### TECHNICAL FIELD

Various examples described herein relate generally to a method and system for generating Generative Artificial Intelligence (Gen AI) responses. Specifically, the disclosed examples are directed to techniques for generating the Gen AI responses using context based hierarchical ontological representations.

### BACKGROUND

Enterprises are increasingly adopting Artificial Intelligence (AI) and automation technologies to support and enhance human decision-making. The technologies enable real-time responses, process optimization, and greater operational efficiency across functions such as customer service, supply chain, product management, and compliance. Existing systems use multiple AI agents that can operate independently or in parallel, each handling a specific aspect of a process. Thus, the existing systems may not be able to coordinate the multiple AI agents within a context of specific industries or domains.

Also, existing multi-agent frameworks are typically generic and do not incorporate domain-specific data structures, workflows, or decision criteria. In retail, for example, a New Product Introduction (NPI) process remains largely manual, requiring coordination among various internal teams including marketing, merchandising, compliance, and operations. This fragmented approach often results in long lead times, with new product launches taking six to nine months or more. The absence of domain-aware multi-agent coordination may limit the practical deployment of the AI in many enterprise scenarios.

### SUMMARY

Implementations of the present disclosure are generally directed to systems and methods for generating industry-specific solutions. Specifically, the disclosed examples are directed to techniques for generating the industry-specific solutions using collaborative Artificial Intelligence (AI) agents.

In some examples, aspects of the subject matter described herein provide a system including a processor and a memory communicably coupled to the processor, wherein the memory comprises processor-executable instructions which, when executed by the processor, cause the processor to receive input data corresponding to an industry-specific problem from at least one data source, wherein the input data comprises user goals, user requirements, and user preferences. Further, the processor is configured to identify a goal context for the industry-specific problem by analyzing a semantic meaning and a user intent of the received input data using an AI model. Furthermore, the processor is configured to select an industry-specific process workflow corresponding to the industry-specific problem based on the identified goal context, wherein the industry-specific process workflow comprises a predefined sequence of domain-specific tasks and decision nodes derived from workflow templates.

In addition, the processor is configured to retrieve at least one of an agentic context, historical intelligence data, group dynamics data for agent compatibility, appropriate agent character data, and historical user feedback data corresponding to the selected industry-specific workflow from agentic data sources and non-agentic data sources. Moreover, the processor is configured to select a plurality of AI agents and agent compatibility rules to execute the user goals based on the retrieved at least one of the agentic context, the historical intelligence data, the group dynamics data for agent compatibility, the appropriate agent character data, and the historical user feedback data, wherein the plurality of AI agents comprise at least one primary agent, a plurality of secondary agents, and a plurality of user agent profiles. Also, the processor is configured to assign the identified agent compatibility rules to each of the selected plurality of AI agents, wherein the identified agent compatibility rules comprise parameters for diversity, an emotional quotient, an educational background data, a generational background data, and socio-economic parameters.

Further, the processor is configured to generate an agentic process workflow for the industry-specific problem based on the assigned identified agent compatibility rules and the plurality of AI agents, wherein the agentic process workflow comprises a plurality of sequential tasks to be performed by each of the plurality of AI agents. Furthermore, the processor is configured to generate at least one candidate solution for the industry-specific problem by executing the generated agentic process workflow using the selected plurality of AI agents in a virtual environment using a Generative Artificial Intelligence (Gen AI) model. Moreover, the processor is configured to output the at least one candidate solution, the agentic process workflow and the agent compatibility rules on a user interface of a user device.

The present disclosure further describes a method, executed by the processor provided herein, for generating the industry-specific solutions using the collaborative AI agents as described with respect to the system herein. The present disclosure also describes non-transitory computer-readable medium coupled to the processor and having instructions stored thereon which, when executed by the processor, cause the processor to perform operations in accordance with the method described herein.

It is appreciated that method in accordance with the present disclosure can include any combination of the aspects and features described herein. That is, the method in accordance with the present disclosure is not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 depicts an example environment that may be used to execute implementations of the present disclosure.

FIG. 2 depicts an example architecture of an industry-specific solution generation system, in accordance with implementations of the present disclosure.

FIG. 3 depicts an example block diagram of an agent optimization engine, in accordance with implementations of the present disclosure.

FIG. 4 depicts an example process flow for generating industry-specific solutions using collaborative Artificial Intelligence (AI) agents, in accordance with implementations of the present disclosure.

FIGS. 5A and 5B are flow diagrams that represents an example method for generating industry-specific solutions using collaborative AI agents, in accordance with implementations of the present disclosure.

FIG. 6 depicts a block diagram of an example computer system that may be used to implement the method for generating the industry-specific solutions using the collaborative AI agents, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of,” by way of example,” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to;” it specifically indicates open-ended inclusion or membership in the so-described combination, group, series, and the like.

The term “a” means “one or more” unless the context clearly indicates a single element.

“First,” “second,” etc., re labels to distinguish components or blocks of otherwise similar names but does not imply any sequence or numerical limitation.

“And/or” for two possibilities means either or both stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope as set forth in the claims.

This disclosure should be interpreted according to the exemplary definitions provided below. In case of a contradiction between the definitions in the definitions section and other sections of this disclosure, this section should prevail. In case of a contradiction between the definitions in this section and a definition or a description in any other document, including in another document incorporated in this disclosure by reference, this section should prevail, even if the definition or the description in the other document is commonly accepted by a person of ordinary skill in the art.

For example, the terms “industry” and “domain” are used interchangeably throughout the document.

Implementations of the present disclosure provide a technique for orchestrating multiple Artificial Intelligence (AI) agents in an industry-specific manner. The technique leverages multimodal and connected enterprise data within an agentic architecture to support context-rich decision-making and high-accuracy task execution. By introducing a industry-specific perspective to agent coordination, the present disclosure enables the transformation of processes through intelligent, adaptive, and cost-efficient multi-agent orchestration. For example, the present disclosure may incorporate factors such as individual agent persona, customer-agent feedback, cross-agent learning, conversation memory, and agentic pairing to maximize output accuracy while minimizing redundant agentic interactions.

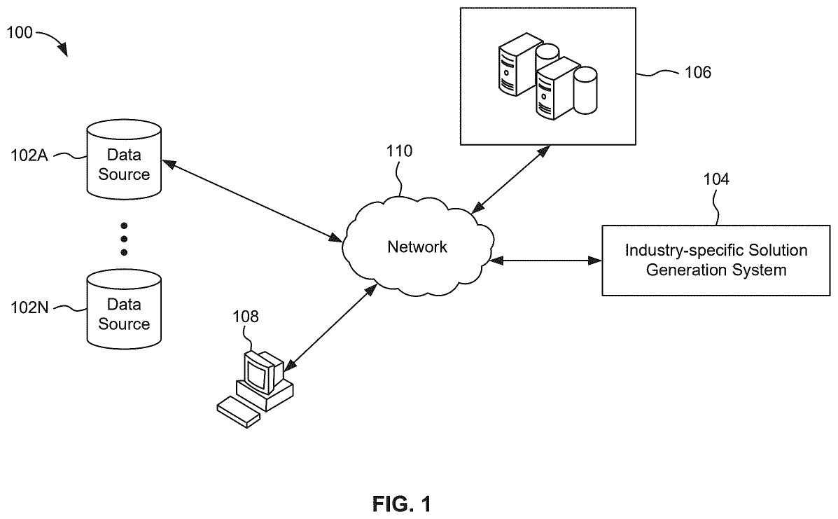

FIG. 1 depicts an example environment 100 that may be used to execute implementations of the present disclosure. The example environment 100, shown in FIG. 1, includes data sources 102A-N, an industry-specific solution generation system 104, a storage device 106 and a user device 108. For simplicity, a single user device 108 is depicted in FIG. 1, however it should be noted that the example environment 100 may include one or more user devices. The data sources 102A-N, the industry-specific solution generation system 104, the storage device 106 and the user device 108 may communicate with each other using a network 110. In some examples, the network 110 may include a Local Area Network (LAN), a Wide Area Network (WAN), the Internet, or a combination thereof. In some examples, the network 110 may be accessed over a wired and/or a wireless communication link.

The plurality of data sources 102A-N may include communication devices and/or computing devices that includes information corresponding to an enterprise or information associated with industry-specific problems. The plurality of data sources 102A-N may include a server such as a web server, a database server, a host server, a proxy server, a virtual server (e.g., executing on a computing hardware), or a server in a cloud computing system.

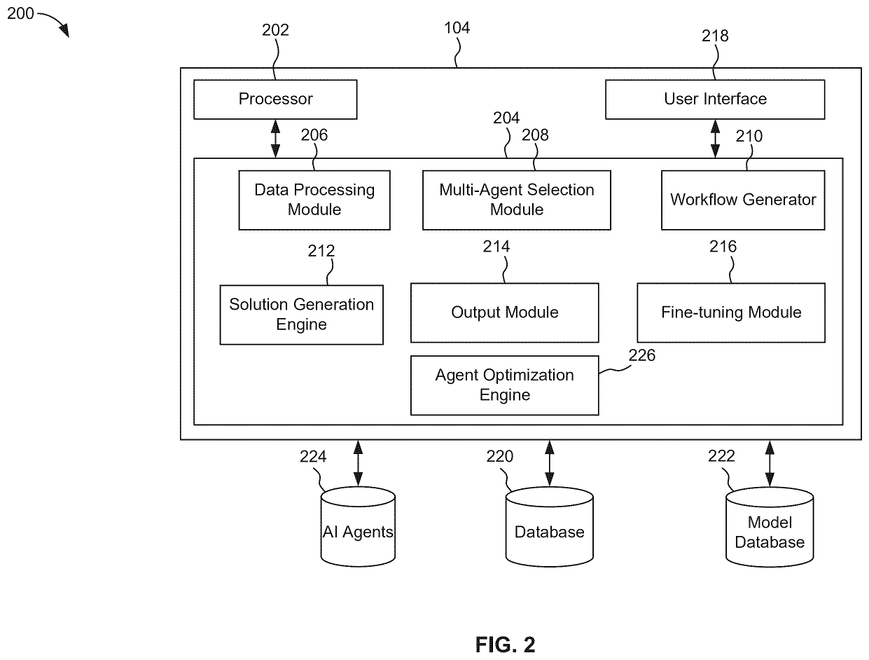

The industry-specific solution generation system 104 is a computing device or an application server that retrieves or obtains the data from the plurality of data sources 102A-N to generate industry-specific solutions. The industry-specific solution generation system 104 may then process and store the solutions in the storage device 106. In some examples, the industry-specific solution generation system 104 may include internal or external servers, quantum computers, desktops, laptops, smartphones, tablets, and/or the like. It is contemplated that implementations of the present disclosure may be realized with any appropriate type of computing device or computing platform. In some examples, the industry-specific solution generation system 104 may display one or more Graphical User Interfaces (GUIs) 218 that enable the user of the user device 108 to interact or provide feedback with a computing platform evaluating the entity. Examples of the computing platform may include content delivery platforms, multimedia-based platforms, and/or the like. Interacting with the computing platform may include providing feedback during the process of generating the industry-specific solutions. For example, the industry-specific solution generation system 104 is described in more detail with reference to FIG. 2.

While only one industry-specific solution generation system 104 is shown in FIG. 1, there may be more than one industry-specific solution generation system 104, and each of the industry-specific solution generation system 104 includes at least one server system. In some examples, the system hosts one or more computer implemented services that users can interact with by using the user device 108. For example, components of enterprise systems and applications can be hosted on one or more of the industry-specific solution generation system 104. In some examples, the industry-specific solution generation system 104 can be provided as an on-premises system that is operated by an enterprise or a third-party taking part in cross-platform interactions and data management. In some examples, the industry-specific solution generation system 104 can be provided as an off-premises system (e.g., cloud or on-demand) that is operated by an enterprise or a third-party on behalf of an enterprise.

In some examples, the user device 108 may include computer executable applications executed thereon. The user device 108 may include a web browser application executed thereon, which can be used to display one or more web pages of applications executing on the industry-specific solution generation system 104. In some examples, the user device 108 can display one or more GUIs that enable the respective the users to interact with the industry-specific solution generation system 104 and/or to present the response generated to the input prompt. In accordance with implementations of the present disclosure, the industry-specific solution generation system 104 may host enterprise applications or systems that require data sharing and data privacy.

In some implementations, the industry-specific solution generation system 104 can be implemented in a cloud environment. In the example of FIG. 1, the industry-specific solution generation system 104 can include various forms of servers including, but not limited to, a web server, a proxy server, a network server, and/or a server pool. In general, server systems accept requests for application services and provide such services to any number of user devices.

Further, the storage device 106 may include any standalone server or any type of computing device that is part of a cloud computing environment for storing data that is ingested by processing the input data. Various examples depicting the process of generating the industry-specific solutions using collaborative AI agents are described in detail in conjunction with FIGS. 2-7.

FIG. 2 depicts an example architecture 200 of the industry-specific solution generation system 104, in accordance with implementations of the present disclosure. As depicted in FIG. 2, the industry-specific solution generation system 104 is communicatively coupled to a database 220 (e.g., the storage device 106) and a model database 222. For example, the database 220 can be a client database or a metadata database. In some examples, the model database 222 may include one or more Multimodal Large Language Models (multimodal LLMs) (also referenced herein as Gen AI models, foundation models, and/or the like). In an implementation, the LLMs may include pre-trained LLMs and generated LLMs. The pre-trained LLMs may be general-purpose Gen AI models like large deep learning neural networks, which may be trained using a broad range of generalized and unlabeled training data to perform one or more tasks, such as, human computer interactions (e.g., question and answering), automating process execution, process planning, generating step-by-step procedures for the process execution, performing data analysis, and/or the like. While implementations of the present disclosure are described in further detail herein with non-limiting reference to the LLMs, it is contemplated that implementations of the present disclosure may be realized using any appropriate foundation models or Machine Learning (ML) models, or AI models.

As depicted in FIG. 2, the industry-specific solution generation system 104 includes a processor 202 and a memory 204. The industry-specific solution generation system 104 may also include other components such as communication interfaces, Input/Output (I/O) devices, and so on (not shown in FIG. 2). The processor 202 may include one or more processors. Examples of the one or more processors may include, but not limited to, microprocessors, microcomputers, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. Among other capabilities, the processor 202 may be programmed to execute computer-readable instructions or processor-readable instructions stored in the memory 204 (also referenced herein as computer-readable storage medium (CRM)) for performing operations according to the present disclosure. The memory 204 may be non-transitory or non-volatile medium, such as a magnetic disk or solid-state non-volatile memory or volatile medium such as Random Access Memory (RAM), and/or the like.

The system 104 further includes a data processing module 206, a multi-agent selection module, a workflow generator 210, a solution generation engine 212, an output module 214, a fine-tuning module 216 and an agent optimization engine 226 as depicted in FIG. 2. The data processing module 206, the multi-agent selection module 208, the workflow generator 210, the solution generation engine 212, the output module 214, the fine-tuning module 216 and the agent optimization engine 226 may be stored in the memory 204 and provided as a downloadable library including the computer-readable instructions. The data processing module 206, the multi-agent selection module 208, the workflow generator 210, the solution generation engine 212, the output module 214, the fine-tuning module 216 and the agent optimization engine 226 may be executed by the processor 202 communicatively coupled with the memory 204 for generating the industry-specific solutions using collaborative AI agents 224. In some examples, the AI agents 224 may include autonomous agents or specialized agents, such as market research agents, supplier engagement agents, product evaluation agents, financial analysis agents, category review agents, supply chain agents, pilot testing agents, perf monitoring agents, vendor negotiation agents, persona agents and the like and are implemented as containerized microservices that execute on external computing devices or within the system 104. The agents 224 are in network communication with the multi-agent orchestration module 208 via Application Programming Interfaces (APIs) or message queues. In some examples, the AI agents 224 may be stored in and executed directly from the memory 204 of the system 104. In this case, inter-agent communication may be facilitated via internal process calls, local sockets, or memory buses.

In an example implementation, the data processing module 206 may receive input data corresponding to an industry-specific problem from one or more data sources (e.g., the data sources 102A-N). For example, the input data may include user goals, user requirements, and user preferences. Further, the data processing module 206 may identify a goal context for the industry-specific problem by analyzing a semantic meaning and a user intent of the received input data using an AI model. In an example implementation, the data processing module 206 may preprocess the received input data by standardizing queries, tokenizing the input data, and extracting user-specified constraints. In some examples, the data processing module 206 integrates a multi-layered privacy-preserving mechanism before any user input is processed or retained. Specifically, personally identifiable information (PII) is either anonymized or pseudonymized prior to ingestion. Schema validation checks are applied at ingestion time to proactively reject inputs containing prohibited data fields, particularly sensitive personal or financial data. To satisfy jurisdictional and enterprise-level data protection requirements, the system 104 utilizes a secure storage infrastructure (i.e., the database 220). All stored data, including agentic memory snapshots, user feedback, and audit logs, is protected using Advanced Encryption Standard (AES) with a 256-bit key length at rest and Transport Layer Security (TLS) version 1.3 during transmission.

The data processing module 206 then generates problem representation data for the preprocessed input data using an embedding model. For example, the problem representation data may include multi-dimensional vectors. In some examples, the data processing module 206 is configured to generate high-dimensional embeddings for use in production Retrieval-Augmented Generation (RAG) pipelines. The data processing module 206 utilizes an embedding model (e.g., a text-embedding-ada-002 model, text-embedding-3 model, or the like) to produce embedding vectors, such as 1,536-dimensional float32 vectors. The embedding vectors are designed to maintain compatibility with existing infrastructure and retrieval systems. Each embedding vector is associated with immutable metadata, including the name of the embedding model and a job identifier (job ID), which ensures reproducibility and consistency across indexing and retrieval operations. For example, the embedding vectors are stored as dense float32 arrays, along with associated metadata such as the embedding model name, version or job ID, and a creation timestamp to ensure traceability and auditability.

In an aspect, storage and indexing of the embedding vectors (also referred as embeddings) are implemented using a database (e.g., a vector agentic database, which forms part of the database 222) that supports native vector types and high-performance vector search capabilities. Raw source documents and corresponding vector embeddings are stored in separate tables in the vector agentic database. Specifically, a documents table is used to store original source content, while a vectors table stores associated embeddings. Each record in the vectors table includes a reference to its corresponding source document and is enriched with comprehensive provenance metadata. The metadata may include source Uniform Resource Identifier (URI), fetch timestamp, license information, and a content checksum for integrity verification. Additionally, immutable fields such as the embedding model name and job ID are stored with each embedding vector to preserve embedding lineage and support future traceability. To manage versioning and the lifecycle of embeddings, the data processing module 206 marks outdated vector records as inactive by setting an associated flag to false. New embeddings generated during reprocessing or re-embedding operations are stored as new rows in the vectors table, each assigned an incremented vector version. The versioning approach facilitates soft deletes, rollbacks, and historical auditing without any loss of data integrity. The data processing module 206 supports flexible metadata schema by including additional metadata fields such as content source type, author, page number (for paginated documents), language, chunk index, token count, and more. The metadata schema may also include structured metadata, such as crawler identifiers, a method of extraction (e.g., Hyper Text Markup Language (HTML) selectors, an Optical Character Recognition (OCR) engine used), OCR confidence scores where applicable, historical retrieval scores that allow tracking of past model behavior over time and the like. The metadata schema may ensure that the embedding vectors can be fully contextualized within a broader content pipeline, supporting robust debugging, auditing, and system evolution. For example, to support model upgrades or architectural changes in the embedding process, the data processing module 206 implements a controlled upgrade mechanism that includes complete re-embedding and reindexing of the content corpus. A rolling reindexing strategy is employed to preserve system 104's availability and continuity throughout the transition period.

Further, the data processing module 206 generates standardized goal representation data for the preprocessed input data by one or more of an entity recognition, a user intent detection, and data structuring of the generated problem representation data using an AI-based semantic analyzer model. Furthermore, the data processing module 206 determines the semantic meaning and the user intent of the received input data based on the generated standardized goal representation data using the AI model. Also, the data processing module 206 outputs the goal context to the multi-agent selection module 208 as a structured representation based on the determined semantic meaning and the user intent using the AI model. In some examples, the goal context includes key entities, relationships, and inferred objectives corresponding to the received input data.

Furthermore, the data processing module 206 may select an industry-specific process workflow corresponding to the industry-specific problem based on the identified goal context. For example, the industry-specific process workflow may include a predefined sequence of domain-specific tasks and decision nodes derived from workflow templates. In an example implementation, the data processing module 206 may map the identified goal context to a plurality of predefined industry-specific process workflows stored in a workflow library stored in the database 222. Further, the data processing module 206 evaluates the plurality of predefined industry-specific process workflows with the user goals, the user requirements, and the user preferences extracted from the received input data based on the mapping. Furthermore, the data processing module 206 ranks the plurality of predefined industry-specific process workflows using a similarity score between goal context embedding and process workflow embeddings. The industry-specific process workflow including the similarity score exceeding a predefined threshold value is then selected based on the ranking. For example, the selected industry-specific process workflow may define a sequence of domain-specific tasks, decision nodes, and evaluation criteria associated with the industry-specific process workflow.

Moreover, the multi-agent selection module 208 may retrieve one or more of an agentic context, historical intelligence data, group dynamics data for agent compatibility, appropriate agent character data, and historical user feedback data corresponding to the selected industry-specific workflow from agentic data sources and non-agentic data sources (i.e., one or more of the data sources 102A-N). In an aspect, the multi-agent selection module 208 generates a plurality of normalized retrieval queries from the identified goal context. The normalized retrieval queries may include canonicalized user goals, extracted constraints and metadata. Further, the multi-agent selection module 208 may select one or more target source categories including the agentic data sources and the non-agentic data sources based on the plurality of normalized retrieval queries. Furthermore, the multi-agent selection module 208 may execute a staged hybrid retrieval pipeline for the selected one or more target source categories using the normalized retrieval queries. For example, the staged pipeline may include one or more of a vector retrieval to obtain dense candidate chunk identifiers, lexical retrieval to obtain lexical candidate chunk identifiers.

In addition, the multi-agent selection module 208 may generate a final set of context chunks by merging the dense candidate chunk identifiers and the lexical candidate chunk identifiers. Moreover, the multi-agent selection module 208 ranks the generated final set of context chunks using a composite scoring function value. In example implementation, the composite scoring function value may combine a cross-encoder score, a vector cosine similarity score, a lexical score, a freshness bonus score and a license penalty score based on a configurable weighted model. Also, the multi-agent selection module 208 may annotate the generated final ranked set of context chunks based on the re-ranking by applying one or more of a trust filter, a licensing filter, a freshness filter, and an Optical Character Recognition (OCR)-confidence filter.

Further, the multi-agent selection module 208 generates an aggregated retrieval result based on the annotation. For example, the aggregated retrieval result may include one or more of the agentic context object, the historical intelligence data, the group dynamics data for agent compatibility, the appropriate agent character data and the historical user feedback data. The multi-agent selection module 208 then computes a relevance score, and a confidence score for each element of the aggregated retrieval result by merging retrieval final scores, embedding similarity measures between a problem embedding and agent skill vectors, and semantic-parser certainty scores. The one or more of the agentic context, the historical intelligence data, the group dynamics data for the agent compatibility, the appropriate agent character data, and the historical user feedback data corresponding to the selected industry-specific workflow are outputted based on the computed relevance score and the confidence score.

In some examples, the multi-agent selection module 208 segments or chunks the input data (i.e., raw text or structured data) into semantically meaningful units that optimize performance of the embedding models and downstream retrieval tasks. In an aspect, by default, content is divided into chunks of approximately 250 tokens, corresponding to 800 to 1,200 characters per chunk. A token-level overlap between adjacent chunks, typically in the range of 10% to 20% and ideally around 15%, is introduced to preserve context continuity and improve semantic coherence across chunk boundaries. For narrative text, such as articles or web pages, the multi-agent selection module 208 applies chunk sizes ranging from 200 to 400 tokens, with paragraph boundaries preserved to maintain readability and thematic integrity. In the case of highly structured content such as technical documentation or patent literature, chunk sizes are extended to 512 to 1,024 tokens. In such cases, logical separators, such as section headers, numbered claims, figure captions, and enumerated lists, are used as chunk boundaries to preserve structural and semantic alignment with the input data. For source code files, the multi-agent selection module 208 segments the content based on syntactic constructs such as function or class definitions. Typical code chunks range from 128 to 256 tokens, with the aim of retaining logical coherence and functional boundaries. In an example, tabular data is transformed into flattened text strings or structured JSON representations prior to chunking. In this example, each chunk typically corresponds to one or more table rows, and a supplemental summary chunk may be generated to capture aggregate insights or table-level metadata. Each chunk derived from tabular data is explicitly labeled with a table tag to facilitate specialized handling during embedding and retrieval. Further, presentation slide content is chunked on a per-slide basis, wherein each individual slide is treated as a discrete chunk. Metadata associated with slide-based chunks includes a slide number and a slide title to enable contextual retrieval. For documents processed via OCR, such as scanned PDFs, the multi-agent selection module 208 retains chunk-level OCR confidence scores and associates each chunk with the originating page number. Chunks exhibiting low OCR confidence scores may be automatically flagged for manual review or exclusion from downstream retrieval pipelines, depending on the desired retrieval precision and quality assurance thresholds.

Further, the multi-agent selection module 208 generates the normalized retrieval queries by performing query normalization in which a raw input query is preprocessed to produce a canonical form. The normalization includes standardizing textual expressions and extracting structured constraints such as temporal ranges (e.g., publication or filing dates), jurisdiction identifiers, or domain-specific filters. The normalization facilitates consistent behavior across varied input formats and supports more accurate downstream matching. Following normalization, the query enters the staged hybrid retrieval pipeline, which combines dense vector retrieval and lexical retrieval techniques to maximize coverage and diversity of relevant candidate chunk identifiers. In the dense retrieval, the query is encoded using the same embedding model employed during content indexing (e.g., a transformer-based text embedding model). A nearest-neighbor vector search is then performed against the vector database, yielding a set of candidate chunk identifiers with a configurable size, typically in the range of top k dense is between 50 to 200. In the lexical retrieval, a sparse retrieval operation, such as a ranking function (BM25) or Term Frequency-Inverse Document Frequency (TF-IDF), is executed using the canonical query terms. The lexical retrieval independently returns a ranked list of content chunks, generally with top k lexical is between 20 to 100 entries. The outputs of the dense and lexical retrieval stages are then merged by taking a union of the chunk identifiers, followed by deduplication to eliminate overlap.

Also, the merged candidate chunk identifiers proceeds to a re-ranking stage, wherein a trained cross-encoder model evaluates each candidate's relevance to the query using pairwise input encoding. The re-ranking stage typically processes between 20 and 50 candidates and assigns a high-precision semantic relevance score to each. Based on the cross-encoder outputs, the top-ranked candidates, usually between 5 and 10, are selected for the final set of content chunks. In a subsequent context assembly stage, the selected final set of content chunks are prepared for incorporation into an LLM prompt. Each content chunk is annotated with a structured citation format, such as source URL, document identifier, chunk index and the like, enabling traceability and post-generation attribution. The full assembled context is constructed to comply with token constraints imposed by a target language model. Thus, ensuring that the assembled context, when combined with the model prompt and expected answer length, remains within the maximum allowable input length. To determine the final ranking of candidate content chunks, the multi-agent selection module 208 applies a composite scoring function that incorporates multiple signal types. The staged and signal-weighted retrieval pipeline enables precise selection and structured formatting of the content chunks for use in generative tasks, where high-quality, traceable context is essential. For example, the final score for each content chunk is computed as:

Final score=0.6·cross encoder score+0.25·vector cosine similarity+0.10·lexical score+8·freshness bonus+ε·license penalty

Where, the cross encoder score represents a semantic match confidence from a cross-encoder model, the vector cosine similarity measures angular similarity between query and content embeddings, the lexical score captures keyword-level relevance from sparse retrieval, the freshness bonus provides a positive adjustment for recently indexed or updated content, the license penalty applies a negative adjustment for content under restrictive or incompatible licenses and δ and ε are tunable hyperparameters that control weighting of time sensitivity and licensing criteria, respectively.

In addition, the multi-agent selection module 208 may select a plurality of AI agents and agent compatibility rules to execute the user goals based on the retrieved at least one of the agentic context, the historical intelligence data, the group dynamics data for agent compatibility, the appropriate agent character data, and the historical user feedback data. The plurality of AI agents may include one or more primary or leader agents and a plurality of secondary agents, and associated plurality of user agent profiles. Each AI agent may maintain a structured persona, described via metadata fields such as persona identifier, domain expertise, skill vector, trust level, cost or latency profile, associated prompt templates and the like. Also, memory management of each AI agent is divided into Short-Term Memory (STM) and Long-Term Memory (LTM). The STM holds recent conversational turns with Least Recently Used (LRU)-based eviction and semantic indexing for efficient retrieval. The LTM stores append-only memory with periodic summarization and snapshotting.

In an example implementation, the multi-agent selection module 208 retrieves candidate AI agent records from a plurality of agent registries and external agent sources (i.e., the AI agents 224 and the database 220, respectively) based on the retrieved one or more of the agentic context, the historical intelligence data, the group dynamics data for agent compatibility, the appropriate agent character data, and the historical user feedback data. For example, retrieval scopes may be local (agent-specific), domain-shared, or global. Retrievals are routed through a Retrieval-Augmented Generation (RAG) gateway, which provides isolated access to RAG stores. The multi-agent selection module 208 may compute a candidate match score for each of the retrieved candidate AI agent by combining a similarity measure between a problem embedding representing the goal context and a skill vector of the candidate AI agent, a historical-performance score derived from the historical intelligence data, a compatibility score derived from the group dynamics data and the agent character data, and a feedback score derived from the historical user feedback data.

Further, the multi-agent selection module 208 applies the agent compatibility rules to the candidate AI agent. The agent compatibility rules may include parameters for diversity, the emotional quotient, the educational background data, the generational background data, socio-economic parameters, a trust level, and permissible tool-access. Furthermore, one or more selection policies are applied to rank remaining candidate AI agents based on candidate match scores and compatibility assessments. In an aspect, the one or more selection policies may include a round-robin policy, a weighted domain relevance policy, a similarity-based matching policy, and a Large Language Model (LLM)-based ranking. Also, the multi-agent selection module 208 may select one or more primary agents as a leader agent based on a historical effectiveness and a domain relevance and the plurality of secondary agents based on complementary skills and compatibility scores with the one or more primary agents, and the plurality of user agent profiles based on ranking positions and the at least one selection policy. For example, the leader agent is selected based on achieving the highest combined score, which is calculated from the difference between customer feedback and cost, plus a compatibility score. The multi-agent selection module 208 then assign a role and corresponding agent-specific execution parameters to each of the selected one or more primary agents and the plurality of secondary agents. The agent-specific execution parameters may include task responsibilities, persona prompts, access scopes, memory scope references and trust and tool-access tokens.

In an example implementation, the multi-agent selection module 208 may retrieve candidate AI agents from an AI registry of the AI agents 224 that includes metadata, such as skill vectors, agent states, domains of expertise, persona descriptions, tool access permissions, and historical performance data. For example, the agent states includes idle, active, awaiting tool, blocked, completed, and failed that are systematically recorded along with state transition events. The AI agents 224 are scored using a multi-factor model that includes semantic similarity between the skill vector and a problem embedding, historical effectiveness in similar workflows, compatibility with other agents, and feedback from prior user sessions. Further, the candidate AI agents are selected using one or more policies, such as round-robin (for fair representation), domain-weighted policies (to prioritize relevance), similarity-based matching, or Large Language Model (LLM)-based ranking. The selected agents are categorized into roles, primary, secondary, or user-profiled, and are assigned the agent compatibility rules. The rules include diversity constraints, emotional and educational backgrounds, trust levels, and socio-economic parameters. The multi-agent selection module 208 then generates execution parameters for each agent, including their task responsibilities, memory scopes, persona prompts, tool-access scopes, and trust tokens.

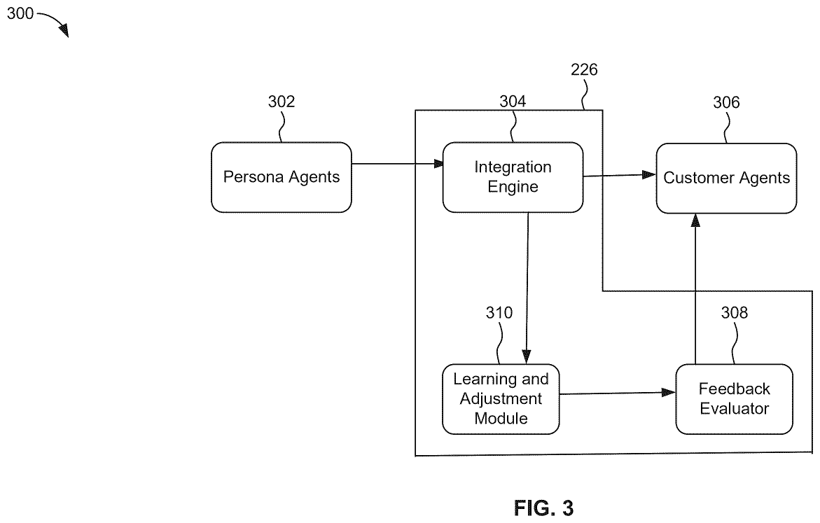

Further, the agent optimization engine 226 may validate the selected one or more primary agents and the plurality of secondary agents with one or more of an availability level, a trust level, performance thresholds and based on real-time user feedback data. Furthermore, the agent optimization engine 226 may iteratively adjust the selected one or more of primary agents and the plurality of secondary agents by modifying the agent compatibility rules until the selected one or more primary agents and the plurality of secondary agents satisfy a selection termination condition. The agent optimization engine 226 then output the selected plurality of AI agents and the assigned agent compatibility rules based on the adjusted one or more primary agents, the plurality of secondary agents and the modified agent compatibility rules. This is explained in more detail with reference to FIG. 3.

Also, the workflow generator 210 may assign the identified agent compatibility rules to each of the selected plurality of AI agents. In some examples, the identified agent compatibility rules may include parameters for diversity, an emotional quotient, educational background data, generational background data, and socio-economic parameters. In an aspect, the agentic process workflow may include a dynamically generated execution plan mapping the predefined sequence of tasks of the industry-specific process workflow to the selected plurality of AI agents based on the assigned agent compatibility rules and inter-agent coordination parameters. Further, the workflow generator 210 may generate an agentic process workflow for the industry-specific problem based on the assigned identified agent compatibility rules and the plurality of AI agents. For example, the agentic process workflow may include a plurality of sequential tasks to be performed by each of the plurality of AI agents. In an aspect, the workflow generator 210 may classify the selected industry-specific process workflow into a plurality of sequential and parallel tasks required to address the industry-specific problem. Further, the workflow generator 210 allocates to one or more of the selected plurality of AI agents based on the assigned agent compatibility rules, role assignments, skill vectors, trust levels, tool-access rights, and agent performance history. Furthermore, the workflow generator 210 generates a Directed Acyclic Graph (DAG) structure by defining execution dependencies between the tasks. For example, the DAG structure may include task ordering, data flows, and decision points. Each node in the DAG corresponds to a task, which may include tool invocation, sub-problem resolution, or inter-agent collaboration. The DAG structure is informed by semantic analysis of the input and by alignment with domain-specific templates stored in a workflow library. The assigned agent compatibility rules are then embedded into the agentic process workflow based on the diversity, the emotional quotient, the educational background data, the generational background data, and the socio-economic parameters. Also, the workflow generator 210 generates execution metadata for the agentic process workflow. For example, the execution metadata may include task identifiers, assigned agent identifiers, input and output parameters, and evaluation criteria.

Furthermore, the solution generation engine 212 may generate one or more candidate solutions for the industry-specific problem by executing the generated agentic process workflow using the selected plurality of AI agents in a virtual environment using a Gen AI model. In some examples, execution of the agentic process workflow is managed using a multi-agent orchestration layer supporting shared threads and a “manager hook” architecture. The orchestrator assumes the role of manager in the workflow, ensuring speaker transitions, turn coordination, and enforcement of execution limits. The agentic process workflow may support structured tool invocation and asynchronous task processing, with the AI agents executing sequential or parallel subtasks, depending on the DAG structure. For efficiency, the system 104 supports batching of micro-tasks and parallelization of independent branches. During execution, the AI agents may invoke tools hosted on Model Context Protocol (MCP) servers through a MCP gateway, which expose capabilities such as web search, file operations, image generation, and code execution through standardized interfaces. The MCP gateway provides a secure proxy to the tools, enforcing authentication, input sanitization, schema validation, rate-limiting, and Role-Based Access Control (RBAC) enforcement. Provenance metadata (including source URI, license, and timestamp) is embedded in all tool responses.

In an example implementation, the solution generation engine 212 may instantiate the selected plurality of AI agents within the virtual environment configured with shared context memory and communication channels. The solution generation engine 212 then executes the plurality of sequential tasks defined in the agentic process workflow by invoking the Gen AI model to simulate outputs of the selected plurality of AI agents. In an aspect, the execution may include one or more of conversation turns, tool invocations, multimodal content generation, and iterative refinement. Further, the solution generation engine 212 determines intermediate outputs, inter-agent communications, and user-agent profile feedback during the execution of the plurality of sequential tasks based on the agentic process workflow. The solution generation engine 212 may evaluate each intermediate output and a final output are evaluated based on a predefined criteria. For example, the predefined criteria may include one or more of an accuracy level, a creativity level, a feasibility level and a compliance level with the user goals and constraints. Furthermore, the solution generation engine 212 may iteratively refine intermediate outputs by re-executing portions of the agentic process workflow based on evaluation scores failing to meet defined thresholds. For example, default thresholds for solution acceptance may be set to 7.0/10, with domain-specific adjustments. In this example, high-regulation domains may demand high feasibility and low risk, while competitive spaces may raise novelty thresholds above 8.0. The solution generation engine 212 then generates one or more candidate solutions based on the intermediate outputs and the evaluated final output from the selected plurality of AI agents. In an aspect, to generate the candidate solutions, the solution generation engine 212 may synthesize and blend insights across disjoint domains. Cross-domain ideation (i.e., domain 1 and domain 2) may be performed by retrieving from semantically distant knowledge bases, mining analogies via graph-matching, and performing concept blending through vector arithmetic that is defined as:

$$blend = α \cdot embedding ( domain 1 ) + ( 1 - α ) \cdot embedding ( domain 1 )$$

where, α is a weighting scaling parameter.

In addition, the output module 214 may output the one or more candidate solutions, the agentic process workflow and the agent compatibility rules on a user interface of a user device (e.g., the user device 108). In some examples, the fine-tuning module 216 may determine performance parameters of the generated one or more candidate solutions in the virtual environment by evaluating an output of execution of the agentic process workflow based on a predefined criteria and user feedback. Further, the fine-tuning module 216 may fine-tune the generated at least one candidate solution, the agentic process workflow and the identified agent compatibility rules based on the determined performance parameters. Also, the fine-tuning module 216 may include outputting the fine-tuned one or more candidate solutions, the fine-tuned agentic process workflow, and the fine-tuned team compatibility rules on the user interface of the user device.

To evaluate the generated candidate solutions, the fine-tuning module 216 employs a set of AI-based evaluators, each applying domain-specific scoring rubrics across five global criteria: novelty, feasibility, cost, risk, and market fit. A scores range from 0 (fatal flaw) to 10 (best-in-class), and include justification traces referencing evidence from RAG outputs. Also, confidence intervals are computed to express scoring uncertainty (e.g., 6.5±0.8), informed by retrieval variability and evaluator divergence. Further, scores provided by the AI-based evaluators are aggregated using a combination of Bayesian weighted mean (accounting for evaluator's trust priors), trimmed mean (to exclude outliers), Borda count (to aggregate rankings), and pairwise voting (to resolve score conflicts). For example, the final score is computed as:

$$Final score = 0.5 \cdot Bayesian mean + 0.3 \cdot Trimmed Mean + 0.2 \cdot Borda Rank$$

In an aspect, to ensure fairness and robustness in evaluation, the fine-tuning module 216 implements a bias calibration framework that dynamically adjusts the scoring behavior of customer agents (i.e., the AI-based evaluators or archetypes). During the evaluation phase, gold-standard reference items, which represent canonical or previously validated outputs, are used to recalibrate weighting parameters of the customer agents. The recalibration process ensures that no single archetype disproportionately over- or under-scores the candidate solutions across repeated evaluations. The recalibration process includes drift analysis, which detects patterns of systematic scoring deviation over time. Prior to score aggregation, z-score normalization is applied to each archetype's raw scores, standardizing them across diverse output ranges and ensuring equitable contribution to final rankings.

Also, in runtime interactions, the system 104 includes automatic masking mechanisms to obscure detected PII within both the agent responses and intermediate outputs. Further ensuring responsible operation, the system 104 applies content moderation filters during both input ingestion and output generation phases. For example, prompt filters are applied to sanitize user instructions by removing unsafe directives or harmful expressions prior to task formulation. Output filters automatically analyze generated content to detect indicators of toxicity, harmful bias, hallucination, or unverifiable factual claims.

Therefore, the system 104 supports fine-tuning of workflows and agents based on performance metrics and real-time feedback. The system 104 enables a dynamic, interpretable, and safe framework for collaborative AI agent orchestration, delivering high-quality, contextual solutions in response to complex problem statements. The agentic process workflow, reinforced by semantic reasoning, modular retrieval, structured evaluation, and compliance mechanisms, provides a scalable architecture for enterprise-grade AI-driven innovation. This framework provides a scalable and interpretable orchestration of autonomous agents capable of solving real-world problems with compliance, safety, and evaluative rigor. The orchestration mechanisms, rooted in dynamic DAG workflows, secure tool access via MCP, structured memory, and diverse evaluation agents, support a modular, resilient, and extensible approach to agentic innovation at enterprise scale.

FIG. 3 depicts an example block diagram 300 of the agent optimization engine 226, in accordance with implementations of the present disclosure. In an example implementation, the block diagram 300 includes independent persona agents 302 (Aⱼ), where j is equal to 1 to N across domains (i.e., psychology, economics, or design). Each persona agent is used for processing domain-specific inputs and producing an output (Oⱼ), defined by an agent-specific function:

$${O}_{j} = {f}_{j} ( inputs of agent j )$$

Further, an integration engine 304 of the of the agent optimization engine 226 then integrates the outputs, representing unique perspectives or domain insights. The integration engine 304 synthesizes the multiple outputs into a consolidated solution (O_{c}) an aggregation function that is defined as:

$${O}_{C} = Combine ( {O}_{1} … {O}_{N} )$$

For example, the combination may be realized through various strategies including simple averaging, weighted summation where weights are assigned based on relevance or domain importance, or adaptive weighting schemes where weights evolve dynamically based on ongoing performance feedback.

Once the integrated solution (O_{c}) is formed, customer agents 306 of the AI agents 224 may evaluate to simulate diverse real-world customer preferences and requirements. Each customer agent independently scores the solution, generating a feedback value Si, indicative of the solution's efficacy and customer satisfaction level within its simulated context:

$${S}_{i} = feedback from cutomer agent i$$

An overall aggregate satisfaction score (S) is then calculated as an arithmetic mean of all individual customer agent scores. The aggregate satisfaction score (S) is calculated as:

$$S = \frac{1}{M} {\sum }_{i = 1}^{M} {S}_{i}$$

In addition, a predefined target satisfaction threshold (T) establishes a minimum acceptable level of customer approval. A feedback evaluator 308 then evaluates the deviation of the achieved satisfaction(S) from the threshold through a loss function defined as a squared error:

$$L = {( T - S )}^{2}$$

For example, the loss function serves as a quantitative measure guiding the optimization of persona agent parameters. To minimize the loss and enhance overall satisfaction, a learning and adjustment module 310 iteratively updates persona agents' internal parameters using a gradient-based adjustment rule:

$$New parameters = Old parameters - η \times Δ$$

where, η denotes the learning rate, which controls the update magnitude, and Δ represents a gradient or direction of a parameter change that is expected to increase the overall satisfaction score S.

In some examples, the agent optimization engine 226 may operate through an iterative feedback loop wherein the persona agents' outputs, integration, customer evaluation, and parameter updates are repeated cyclically. The loop continues until at least one termination criterion is satisfied: either the satisfaction score S reaches or surpasses the Threshold T (i.e., S≥T), the improvement in satisfaction is negligible over K consecutive iterations, or a maximum allowable number of iterations is completed to prevent excessive computational overhead. Thus, allowing the system to accommodate numerous persona agents and customer agents concurrently, promoting modularity for easy integration of additional agents or domains. Configurability features including adjustable learning rates n, customizable feedback weighting strategies, and definable satisfaction thresholds T, enables tailored optimization for various application contexts. The feedback-driven iterative learning process, rigorously formalized through the described equations, yields solutions that are not only domain-informed but also finely tuned to meet multi-faceted customer requirements, thereby enhancing the likelihood of real-world success.

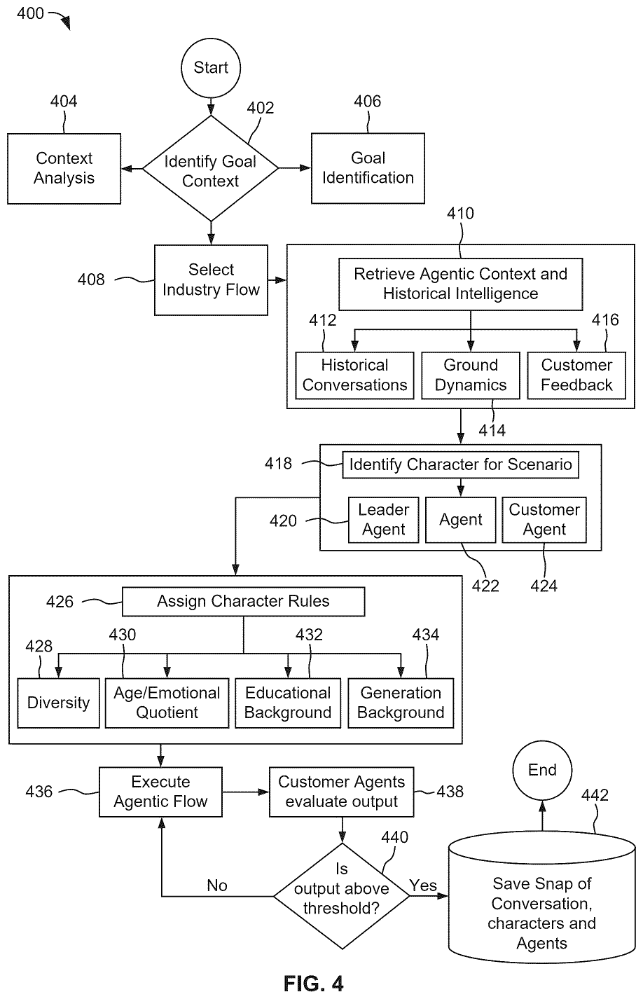

FIG. 4 depicts an example process flow 400 for generating industry-specific solutions using collaborative AI agents, in accordance with implementations of the present disclosure. In an example implementation, in the process flow 400, an agentic process at a start node 402, where the specific goal context is identified. For example, the specific goal context is identified by decomposing a high-level goal into finer-grained components to precisely capture context in which the goal is to be achieved. The goal context identification enables the system 104 to tailor subsequent interactions accurately. Concurrently, context analysis 404 and goal identification 406 are performed to refine the understanding of environmental conditions and desired outcomes related to the goal.

Upon determination of the goal context, appropriate industry flow 408 is selected. The industry flow or workflow is selected is based on a domain relevant to the goal, ensuring that operational parameters and interaction protocols align with domain-specific requirements and standards, such as those applicable to retail, healthcare, or financial sectors. Further, agentic context and historical intelligence 410 are retrieved from memory, which includes multiple data sources containing historical conversations 412 relevant to similar scenarios are accessed to provide proven interaction patterns, ground dynamics 414 reflecting the compatibility and group behavior of agents and customer feedback 416 encompassing feedback from both agentic and non-agentic previous interactions. The customer feedback is incorporated to align responses with user expectations and satisfaction metrics.

Following retrieval, relevant AI agents are identified 418 by distinguishing between three primary agent roles, a leader agent 420 responsible for overall strategy and coordination, one or more agent characters 422 who execute domain-specific tasks, and customer agents 424 who simulate customer perspectives and provide evaluative feedback. Furthermore, agent compatibility rules are assigned to each identified agent, maximizing team diversity and effectiveness. The rules encompass a range of attributes including diversity 428 to ensure broad representation of perspectives, age and emotional quotient 430 to modulate interpersonal dynamics, educational background 432 to incorporate varied knowledge bases and generation background 434 to reflect cultural and communication style differences. Additional socio-economic factors may also be incorporated to enhance the contextual suitability of each character. Moreover, the agentic flow is executed where the leader agent, domain agents, and customer agents interact dynamically within a defined scenario. The execution simulates realistic conversational or task-oriented exchanges aimed at accomplishing the stated goal. Following execution, the customer agents evaluate the generated output 438. The evaluation is quantified against predetermined quality metrics by determining whether the output exceeds an acceptability threshold 440. If the output meets or surpasses the threshold, a comprehensive snapshot of the entire interaction, including conversations, character configurations, and agent states is stored 442. The archival process enriches the system's historical memory, facilitating improved performance in subsequent iterations. If the output fails to meet the quality threshold, the process loops back to step 436, repeating the execution and evaluation cycle. The iterative process continues until the output satisfies the criteria or a predefined stopping condition is met. For example, throughout each iteration, the system 104 records z snapshot of the interaction in z dynamic memory, enabling contextual learning and continuous improvement. Additionally, cost associated with each interaction flow is calculated and stored to monitor resource expenditure. Should the cost exceed a predefined threshold or if performance improvements stagnate, the system reverts to step 410 to reassess and potentially adjust the agentic context retrieval and team composition before recommencing the process.

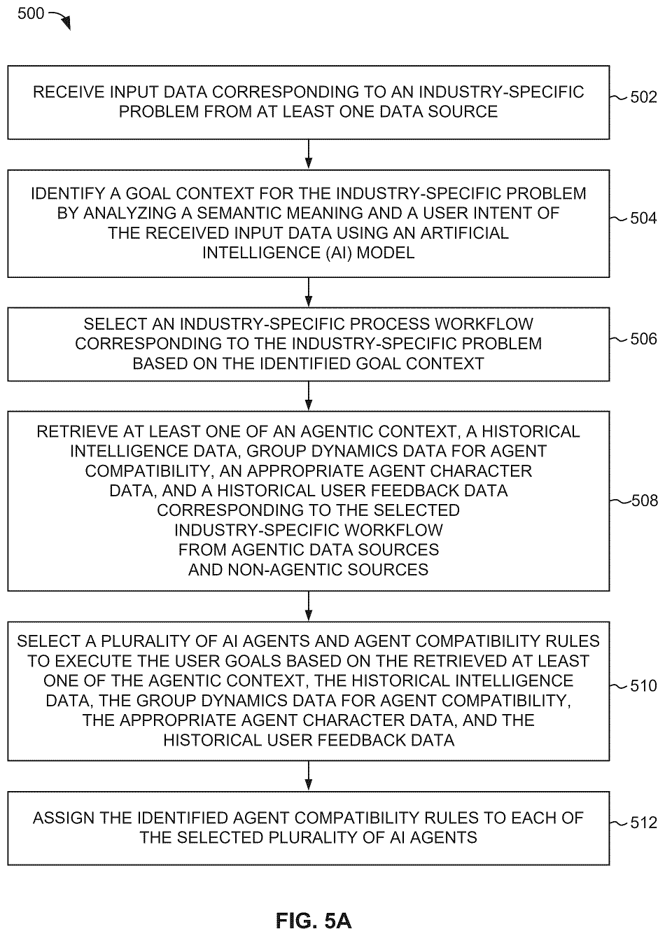

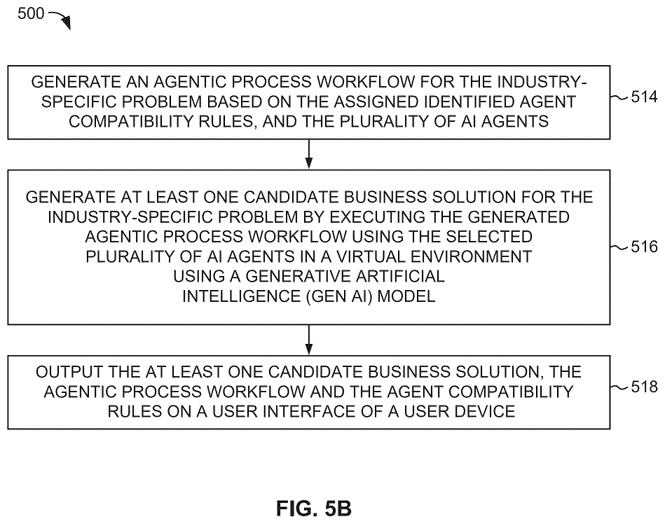

FIGS. 5A and 5B are flow diagrams that represents an example processor-executable method 500 for generating industry-specific solutions using collaborative AI agents, in accordance with implementations of the present disclosure. In some implementations, the method 500 may be executed by the processor 202 (including the one or more processors), as described in relation to FIGS. 2-4.

In an example implementation, the method 500 may include receiving input data 502 corresponding to an industry-specific problem from one or more data sources (e.g., the data sources 102A-N). For example, the input data may include user goals, user requirements, and user preferences. Further, the method 500 may include identifying a goal context 504 for the industry-specific problem by analyzing a semantic meaning and a user intent of the received input data using an AI model. In an example implementation, the received input data is preprocessed by standardizing queries, tokenizing the input data, and extracting user-specified constraints. Problem representation data for the preprocessed input data is then generated using an embedding model. For example, the problem representation data may include multi-dimensional vectors. Further, standardized goal representation data for the preprocessed input data is generated by one or more of an entity recognition, a user intent detection, and data structuring of the generated problem representation data using an AI-based semantic analyzer model. Furthermore, the semantic meaning and the user intent of the received input data are determined based on the generated standardized goal representation data using the AI model. Also, the goal context is outputted as a structured representation based on the determined semantic meaning and the user intent using the AI model. In some examples, the goal context includes key entities, relationships, and inferred objectives corresponding to the received input data.

Furthermore, the method 500 may include selecting an industry-specific process workflow 506 corresponding to the industry-specific problem based on the identified goal context. For example, the industry-specific process workflow may include a predefined sequence of domain-specific tasks and decision nodes derived from workflow templates. In an example implementation, the identified goal context is mapped to a plurality of predefined industry-specific process workflows stored in a workflow library. Further, the plurality of predefined industry-specific process workflows are evaluated with the user goals, the user requirements, and the user preferences extracted from the received input data based on the mapping. Furthermore, the plurality of predefined industry-specific process workflows are ranked using a similarity score between goal context embedding and process workflow embeddings. The industry-specific process workflow including the similarity score exceeding a predefined threshold value is then selected based on the ranking. For example, the selected industry-specific process workflow may define a sequence of domain-specific tasks, decision nodes, and evaluation criteria associated with the industry-specific process workflow.

Moreover, the method 500 may include retrieving one or more of an agentic context, historical intelligence data, group dynamics data for agent compatibility, appropriate agent character data, and historical user feedback data 508 corresponding to the selected industry-specific workflow from agentic data sources and non-agentic data sources. In an aspect, a plurality of normalized retrieval queries are generated from the identified goal context. The normalized retrieval queries may include canonicalized user goals, extracted constraints and metadata. Further, one or more target source categories including the agentic data sources and the non-agentic data sources are selected based on the plurality of normalized retrieval queries. Furthermore, a staged hybrid retrieval pipeline is executed for the selected one or more target source categories using the normalized retrieval queries. For example, the staged pipeline may include one or more of a vector retrieval to obtain dense candidate chunk identifiers, lexical retrieval to obtain lexical candidate chunk identifiers.

In addition, a final set of context chunks is generated by merging the dense candidate chunk identifiers and the lexical candidate chunk identifiers. Moreover, the generated final set of context chunks are ranked using a composite scoring function value. In example implementation, the composite scoring function value may combine a cross-encoder score, a vector cosine similarity score, a lexical score, a freshness bonus score and a license penalty score based on a configurable weighted model.

Also, the generated final ranked set of context chunks is annotated based on the re-ranking by applying one or more of a trust filter, a licensing filter, a freshness filter, and an OCR-confidence filter. Further, an aggregated retrieval result is generated based on the annotation. For example, the aggregated retrieval result may include one or more of the agentic context object, the historical 5 intelligence data, the group dynamics data for agent compatibility, the appropriate agent character data and the historical user feedback data. A relevance score, and a confidence score for each element of the aggregated retrieval result are then computed by merging retrieval final scores, embedding similarity measures between a problem embedding and agent skill vectors, and semantic-parser certainty scores. The one or more of the agentic context, the historical intelligence data, the group dynamics data for the agent compatibility, the appropriate agent character data, and the historical user feedback data corresponding to the selected industry-specific workflow are outputted based on the computed relevance score and the confidence score.

In addition, the method 500 may include selecting a plurality of AI agents and agent compatibility rules 510 to execute the user goals based on the retrieved at least one of the agentic context, the historical intelligence data, the group dynamics data for agent compatibility, the appropriate agent character data, and the historical user feedback data. The plurality of AI agents may include one or more primary or leader agents and a plurality of secondary agents, and associated plurality of user agent profiles. In an example implementation, candidate AI agent records are retrieved from a plurality of agent registries and external agent sources based on the retrieved one or more of the agentic context, the historical intelligence data, the group dynamics data for agent compatibility, the appropriate agent character data, and the historical user feedback data. A candidate match score is then computed for each of the retrieved candidate AI agent by combining a similarity measure between a problem embedding representing the goal context and a skill vector of the candidate AI agent, a historical-performance score derived from the historical intelligence data, a compatibility score derived from the group dynamics data and the agent character data, and a feedback score derived from the historical user feedback data.

Further, the agent compatibility rules are applied to the candidate AI agent. The agent compatibility rules may include parameters for diversity, the emotional quotient, the educational background data, the generational background data, socio-economic parameters, a trust level, and permissible tool-access. Furthermore, one or more selection policies are applied to rank remaining candidate AI agents based on candidate match scores and compatibility assessments. In an aspect, the one or more selection policies may include a round-robin policy, a weighted domain relevance policy, a similarity-based matching policy, and a Large Language Model (LLM)-based ranking. Also, one or more primary agents are selected as a leader agent based on a historical effectiveness and a domain relevance and the plurality of secondary agents are selected based on complementary skills and compatibility scores with the one or more primary agents, and the plurality of user agent profiles based on ranking positions and the at least one selection policy. A role and corresponding agent-specific execution parameters are then assigned to each of the selected one or more primary agents and the plurality of secondary agents. The agent-specific execution parameters may include task responsibilities, persona prompts, access scopes, memory scope references and trust and tool-access tokens.

Further, the selected one or more primary agents and the plurality of secondary agents are validated with one or more of an availability level, a trust level, performance thresholds and based on real-time user feedback data. Furthermore, the selected one or more of primary agents and the plurality of secondary agents are iteratively adjusted by modifying the agent compatibility rules until the selected one or more primary agents and the plurality of secondary agents satisfy a selection termination condition. The selected plurality of AI agents and the assigned agent compatibility rules are outputted based on the adjusted one or more primary agents, the plurality of secondary agents and the modified agent compatibility rules.

Also, the method 500 may include assigning 512 the identified agent compatibility rules to each of the selected plurality of AI agents. In some examples, the identified agent compatibility rules may include parameters for diversity, an emotional quotient, educational background data, generational background data, and socio-economic parameters. Further, the method 500 may include generating an agentic process workflow 514 for the industry-specific problem based on the assigned identified agent compatibility rules and the plurality of AI agents. For example, the agentic process workflow may include a plurality of sequential tasks to be performed by each of the plurality of AI agents. In an aspect, the selected industry-specific process workflow is classified into a plurality of sequential and parallel tasks required to address the industry-specific problem.

Further, each task is allocated to one or more of the selected plurality of AI agents based on the assigned agent compatibility rules, role assignments, skill vectors, trust levels, tool-access rights, and agent performance history. Furthermore, a Directed Acyclic Graph (DAG) structure is generated by defining execution dependencies between the tasks. The DAG structure may include task ordering, data flows, and decision points. The assigned agent compatibility rules are then embedded into the agentic process workflow based on the diversity, the emotional quotient, the educational background data, the generational background data, and the socio-economic parameters. Also, execution metadata is generated for the agentic process workflow. For example, the execution metadata may include task identifiers, assigned agent identifiers, input and output parameters, and evaluation criteria.

Furthermore, the method 500 may include generating one or more candidate solutions 516 for the industry-specific problem by executing the generated agentic process workflow using the selected plurality of AI agents in a virtual environment using a Gen AI model. In an example implementation, the selected plurality of AI agents are instantiated within the virtual environment configured with shared context memory and communication channels. The plurality of sequential tasks defined in the agentic process workflow are then executed by invoking the Gen AI model to simulate outputs of the selected plurality of AI agents. In an aspect, the execution may include one or more of conversation turns, tool invocations, multimodal content generation, and iterative refinement. Further, intermediate outputs, inter-agent communications, and user-agent profile feedback are determined during the execution of the plurality of sequential tasks based on the agentic process workflow. Each intermediate output and a final output are evaluated based on a predefined criteria, wherein the predefined criteria comprises at least one of an accuracy level, a creativity level, a feasibility level and a compliance level with the user goals and constraints. Furthermore, the intermediate outputs are iteratively refined by re-executing portions of the agentic process workflow based on evaluation scores failing to meet defined thresholds. The one or more candidate solutions are generated based on the intermediate outputs and the evaluated final output from the selected plurality of AI agents.

In addition, the method 500 may include outputting 518 the one or more candidate solutions, the agentic process workflow and the agent compatibility rules on a user interface of a user device (e.g., the user device 108). The agentic process workflow may include a dynamically generated execution plan mapping the predefined sequence of tasks of the industry-specific process workflow to the selected plurality of AI agents based on the assigned agent compatibility rules and inter-agent coordination parameters.

In some examples, the method 500 may include determining performance parameters of the generated one or more candidate solutions in the virtual environment by evaluating an output of execution of the agentic process workflow based on a predefined criteria and user feedback. Further, the method may include fine-tuning the generated at least one candidate solution, the agentic process workflow and the identified agent compatibility rules based on the determined performance parameters. Also, the method 500 may include outputting the fine-tuned one or more candidate solutions, the fine-tuned agentic process workflow, and the fine-tuned team compatibility rules on the user interface of the user device.

Implementations of the present disclosure enables coordinated interaction among multiple AI agents, each with a defined agent persona or profile and specialized role. By incorporating domain-specific factors such as structured workflows, contextual data, and specialized decision criteria, the present disclosure supports more accurate and efficient automation of enterprise processes. Also, the implementation of the present disclosure may utilize customer-agent feedback, cross-agent learning, persistent conversation memory, and agentic pairing strategies to optimize agent behavior and reduce unnecessary interactions.

The present disclosure also enables cost-optimized orchestration by minimizing a number of LLM inference calls, which are among the most resource-intensive operations in Gen AI systems. By optimizing agentic interactions, the system can reduce LLM inferencing costs associated with specific industry processes by approximately 20-30%. In addition, the system may ensure improved output quality by incorporating simulated customer feedback into the orchestration logic. The feedback loop allows the system to adapt and self-correct based on expected user preferences or outcomes, thereby improving result accuracy by an estimated 15-20%. The orchestration architecture also supports multimodal and connected enterprise data, further enhancing context-awareness and domain alignment. Overall, the system improves speed, creativity, accuracy, and energy efficiency across complex, multi-agent AI workflows in domain-specific enterprise applications.

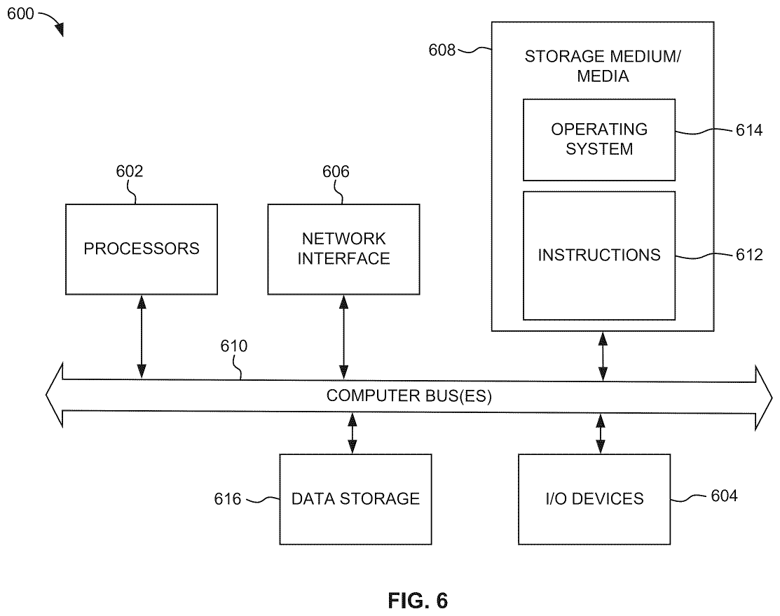

FIG. 6 illustrates a computer system 600 (i.e., the industry-specific solution generation system 104) that may be used to implement the method for generating industry-specific solutions using collaborative AI agents, in accordance with implementations of the present disclosure. More particularly, computing machines such as desktops, laptops, smartphones, tablets, and wearables which may be used to perform the software testing. The computer system 600 may include additional components not shown and that some of the process components described may be removed and/or modified. In another example, a computer system 600 may be deployed on external-cloud platforms such as cloud, internal corporate cloud computing clusters, organizational computing resources, and/or the like.

The computer system 600 includes processor(s) 602, such as a central processing unit, ASIC or another type of processing circuit, input/output devices 604, such as a display, mouse keyboard, etc., a network interface 606, such as a Local Area Network (LAN), a wireless 602.11x LAN, a 3G or 4G mobile WAN or a WiMax WAN, and a computer-readable medium 608. Each of these components may be operatively coupled to a bus 610. The computer-readable medium 608 may be any suitable medium that participates in providing instructions to the processor(s) 602 for execution. For example, the computer-readable medium 608 may be non-transitory or non-volatile medium, such as a magnetic disk or solid-state non-volatile memory or volatile medium such as RAM. The instructions or modules stored on the computer-readable medium 608 may include machine-readable instructions 612 executed by the processor(s) 602 that cause the processor(s) 602 to perform the methods and functions of the system 104.

The system 600 may be implemented as software stored on a non-transitory processor-readable medium and executed by the processor(s) 602. For example, the computer-readable medium 608 may store an operating system 614, such as MAC OS, MS WINDOWS, UNIX, or LINUX, and code, for the system 600. The operating system 614 may be multi-user, multiprocessing, multitasking, multithreading, real-time, and the like. For example, during runtime, the operating system 614 is running and the code for the computer system 600 is executed by the processor(s) 602.

The computer system 600 may include a data storage 616, which may include non-volatile data storage. The data storage 616 stores any data used or generated by the system 104. The network interface 606 connects the computer system 600 to internal systems for example, via a LAN. Also, the network interface 606 may connect the computer system 600 to the Internet. For example, the computer system 600 may connect to web browsers and other external applications and systems via the network interface 606.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, the system 104). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 602 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet. The computing system may include clients and servers. A client and server are generally remote from each other and interact through a communication network. The relationship between client and server arises by virtue of computer programs running on the respective computers and having a client-server relationship with each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination with a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together into a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive input data corresponding to an industry-specific problem from at least one data source, wherein the input data comprises user goals, user requirements, and user preferences;
identify a goal context for the industry-specific problem by analyzing a semantic meaning and a user intent of the received input data using an Artificial Intelligence (AI) model;
select an industry-specific process workflow corresponding to the industry-specific problem based on the identified goal context, wherein the industry-specific process workflow comprises a predefined sequence of domain-specific tasks and decision nodes derived from workflow templates;
retrieve at least one of an agentic context, historical intelligence data, group dynamics data for agent compatibility, appropriate agent character data, and historical user feedback data corresponding to the selected industry-specific workflow from agentic data sources and non-agentic data sources;
select a plurality of AI agents and agent compatibility rules to execute the user goals based on the retrieved at least one of the agentic context, the historical intelligence data, the group dynamics data for agent compatibility, the appropriate agent character data, and the historical user feedback data, wherein the plurality of AI agents comprise at least one primary agent, a plurality of secondary agents, and a plurality of user agent profiles;
assign the identified agent compatibility rules to each of the selected plurality of AI agents, wherein the identified agent compatibility rules comprise parameters for diversity, an emotional quotient, an educational background data, a generational background data, and socio-economic parameters;
generate an agentic process workflow for the industry-specific problem based on the assigned identified agent compatibility rules and the plurality of AI agents, wherein the agentic process workflow comprises a plurality of sequential tasks to be performed by each of the plurality of AI agents;
generate at least one candidate solution for the industry-specific problem by executing the generated agentic process workflow using the selected plurality of AI agents in a virtual environment using a Generative Artificial Intelligence (Gen AI) model; and
output the at least one candidate solution, the agentic process workflow and the agent compatibility rules on a user interface of a user device.

2. The system of claim 1, wherein the processor is to:
determine performance parameters of the generated at least one candidate solution in the virtual environment by evaluating an output of execution of the agentic process workflow based on a predefined criteria and user feedback;
fine-tune the generated at least one candidate solution, the agentic process workflow and the identified agent compatibility rules based on the determined performance parameters; and
output the fine-tuned at least one candidate solution, the fine-tuned agentic process workflow and the fine-tuned team compatibility rules on the user interface of the user device.

3. The system of claim 1, wherein to identify the goal context for the industry-specific problem by analyzing the semantic meaning and the user intent of the received input data using the AI model, the processor is to:
preprocess the received input data by standardizing queries, tokenizing the input data, and extracting user-specified constraints;
generate problem representation data for the preprocessed input data using an embedding model, wherein the problem representation data comprises multi-dimensional vectors;
generate standardized goal representation data for the preprocessed input data by performing at least one of an entity recognition, a user intent detection, and data structuring of the generated problem representation data using an AI-based semantic analyzer model;
determine the semantic meaning and the user intent of the received input data based on the generated standardized goal representation data using the AI model; and
output the goal context as a structured representation based on the determined semantic meaning and the user intent using the AI model, wherein the goal context comprises key entities, relationships, and inferred objectives corresponding to the received input data.

4. The system of claim 1, wherein to select the industry-specific process workflow corresponding to the industry-specific problem based on the identified goal context, the processor is to:
map the identified goal context to a plurality of predefined industry-specific process workflows stored in a workflow library;
evaluate the plurality of predefined industry-specific process workflows with the user goals, the user requirements, and the user preferences extracted from the received input data based on the mapping;
rank the plurality of predefined industry-specific process workflows using a similarity score between goal context embedding and process workflow embeddings; and
select the industry-specific process workflow comprising the similarity score exceeding a predefined threshold value based on the ranking, wherein the selected industry-specific process workflow defines a sequence of domain-specific tasks, decision nodes, and evaluation criteria associated with the industry-specific process workflow.

5. The system of claim 1, wherein to retrieve the at least one of the agentic context, the historical intelligence data, the group dynamics data for the agent compatibility, the appropriate agent character data, and the historical user feedback data corresponding to the selected industry-specific workflow from the agentic data sources and the non-agentic data sources, the processor is to:
generate a plurality of normalized retrieval queries from the identified goal context, wherein the normalized retrieval queries comprise canonicalized user goals, extracted constraints and metadata;
select at least one target source category comprising the agentic data sources and the non-agentic data sources based on the plurality of normalized retrieval queries;
execute a staged hybrid retrieval pipeline for the selected at least one target source category using the plurality of normalized retrieval queries, wherein the staged pipeline comprises at least one of a vector retrieval to obtain dense candidate chunk identifiers, lexical retrieval to obtain lexical candidate chunk identifiers;
generate a final set of context chunks by merging the dense candidate chunk identifiers and the lexical candidate chunk identifiers;
rank the generated final set of context chunks using a composite scoring function value, wherein the composite scoring function value combines a cross-encoder score, a vector cosine similarity score, a lexical score, a freshness bonus score, and a license penalty score based on a configurable weighted model;
annotate the generated final ranked set of context chunks based on ranking by applying at least one of a trust filter, a licensing filter, a freshness filter, and an Optical Character Recognition (OCR)-confidence filter;
generate an aggregated retrieval result comprising at least one of the agentic context object, the historical intelligence data, the group dynamics data for agent compatibility, the appropriate agent character data and the historical user feedback data based on the annotation;
compute a relevance score and a confidence score for each element of the aggregated retrieval result by merging retrieval final scores, and embedding similarity measures between a problem embedding and agent skill vectors, and semantic-parser certainty scores; and
output the at least one of the agentic context, the historical intelligence data, the group dynamics data for the agent compatibility, the appropriate agent character data, and the historical user feedback data corresponding to the selected industry-specific workflow based on the computed relevance score and the confidence score.

6. The system of claim 1, wherein to select the plurality of AI agents and the agent compatibility rules to execute the user goals based on the retrieved at least one of the agentic context, the historical intelligence data, the group dynamics data for agent compatibility, the appropriate agent character data, and the historical user feedback data, the processor is to:
retrieve candidate AI agent records from a plurality of agent registries and external agent sources based on the retrieved at least one of the agentic context, the historical intelligence data, the group dynamics data for agent compatibility, the appropriate agent character data, and the historical user feedback data;
compute a candidate match score for each of the retrieved candidate AI agent by combining a similarity measure between a problem embedding representing the goal context and a skill vector of the candidate AI agent, a historical-performance score derived from the historical intelligence data, a compatibility score derived from the group dynamics data and the agent character data, and a feedback score derived from the historical user feedback data;
apply the agent compatibility rules to the candidate AI agent, wherein the agent compatibility rules comprise the parameters for diversity, the emotional quotient, the educational background data, the generational background data, the socio-economic parameters, a trust level, and permissible tool-access;
apply at least one selection policy to rank remaining candidate AI agents based on candidate match scores and compatibility assessments, wherein the at least one selection policy comprises a round-robin policy, a weighted domain relevance policy, a similarity-based matching policy, and a Large Language Model (LLM)-based ranking;
select at least one primary agent as a leader agent based on a historical effectiveness and a domain relevance, the plurality of secondary agents based on complementary skills and compatibility scores with the at least one primary agent, and the plurality of user agent profiles based on ranking positions and the at least one selection policy; and
assign a role and corresponding agent-specific execution parameters to each of the selected at least one primary agent and the plurality of secondary agents, wherein the agent-specific execution parameters comprise task responsibilities, persona prompts, access scopes, memory scope references and trust and tool-access tokens.

7. The system of claim 6, wherein the processor is to:
validate the selected at least one primary agent and the plurality of secondary agents with at least one of an availability level, a trust level, performance thresholds and based on real-time user feedback data;
iteratively adjust the selected at least one primary agent and the plurality of secondary agents by modifying the agent compatibility rules until the selected at least one primary agent and the plurality of secondary agents satisfy a selection termination condition; and
output the selected plurality of AI agents and the assigned agent compatibility rules based on the adjusted at least one primary agent, the plurality of secondary agents and the modified agent compatibility rules.

8. The system of claim 1, wherein to generate the agentic process workflow for the industry-specific problem based on the assigned agent compatibility rules and the plurality of AI agents, the processor is to:
classify the selected industry-specific process workflow into a plurality of sequential and parallel tasks required to address the industry-specific problem;
allocate each task to at least one of the selected plurality of AI agents based on the assigned agent compatibility rules, role assignments, skill vectors, trust levels, tool-access rights, and agent performance history;
generate a Directed Acyclic Graph (DAG) structure by defining execution dependencies between the tasks, wherein the DAG structure comprises task ordering, data flows, and decision points;
embed the assigned agent compatibility rules into the agentic process workflow based on the diversity, the emotional quotient, the educational background data, the generational background data, and the socio-economic parameters; and
generate execution metadata for the agentic process workflow, wherein the execution metadata comprises task identifiers, assigned agent identifiers, input and output parameters, and evaluation criteria.

9. The system of claim 1, wherein to generate the at least one candidate solution for the industry-specific problem by executing the generated agentic process workflow using the selected plurality of AI agents in the virtual environment using the Gen AI model, the processor is to:
instantiate the selected plurality of AI agents within the virtual environment configured with shared context memory and communication channels;
execute the plurality of sequential tasks defined in the agentic process workflow by invoking the Gen AI model to simulate outputs of the selected plurality of AI agents, wherein the execution comprises at least one of conversation turns, tool invocations, multimodal content generation, and iterative refinement;
determine intermediate outputs, inter-agent communications, and user-agent profile feedback during the execution of the plurality of sequential tasks based on the agentic process workflow;
evaluate each intermediate output and a final output based on a predefined criteria, wherein the predefined criteria comprises at least one of an accuracy level, a creativity level, a feasibility level and a compliance level with the user goals and constraints;
iteratively refine the intermediate outputs by re-executing portions of the agentic process workflow based on evaluation scores failing to meet defined thresholds; and
generate at least one candidate solution based on the intermediate outputs and the evaluated final output from the selected plurality of AI agents.

10. The system of claim 1, wherein the agentic process workflow comprises a dynamically generated execution plan mapping the plurality of sequential tasks of the industry-specific process workflow to the selected plurality of AI agents based on the assigned agent compatibility rules and inter-agent coordination parameters.

11. A method comprising:
receiving, by a processor, input data corresponding to an industry-specific problem from at least one data source, wherein the input data comprises user goals, user requirements, and user preferences;
identifying, by the processor, a goal context for the industry-specific problem by analyzing a semantic meaning and a user intent of the received input data using an Artificial Intelligence (AI) model;
selecting, by the processor, an industry-specific process workflow corresponding to the industry-specific problem based on the identified goal context, wherein the industry-specific process workflow comprises a predefined sequence of domain-specific tasks and decision nodes derived from workflow templates;
retrieving, by the processor, at least one of an agentic context, historical intelligence data, group dynamics data for agent compatibility, appropriate agent character data, and historical user feedback data corresponding to the selected industry-specific workflow from agentic data sources and non-agentic data sources;
selecting, by the processor, a plurality of AI agents and agent compatibility rules to execute the user goals based on the retrieved at least one of the agentic context, the historical intelligence data, the group dynamics data for agent compatibility, the appropriate agent character data, and the historical user feedback data, wherein the plurality of AI agents comprise at least one primary agent, a plurality of secondary agents, and associated plurality of user agent profiles;
assigning, by the processor, the identified agent compatibility rules to each of the selected plurality of AI agents, wherein the identified agent compatibility rules comprise parameters for diversity, an emotional quotient, educational background data, generational background data, and socio-economic parameters;
generating, by the processor, an agentic process workflow for the industry-specific problem based on the assigned identified agent compatibility rules and the plurality of AI agents, wherein the agentic process workflow comprises a plurality of sequential tasks to be performed by each of the plurality of AI agents;
generating, by the processor, at least one candidate solution for the industry-specific problem by executing the generated agentic process workflow using the selected plurality of AI agents in a virtual environment using a Generative Artificial Intelligence (Gen AI) model; and
outputting, by the processor, the at least one candidate solution, the agentic process workflow and the agent compatibility rules on a user interface of a user device.

12. The method of claim 11, further comprising:
determining, by the processor, performance parameters of the generated at least one candidate solution in the virtual environment by evaluating an output of execution of the agentic process workflow based on a predefined criteria and user feedback;
fine-tuning, by the processor, the generated at least one candidate solution, the agentic process workflow and the identified agent compatibility rules based on the determined performance parameters; and
outputting, by the processor, the fine-tuned at least one candidate solution, the fine-tuned agentic process workflow, and the fine-tuned team compatibility rules on the user interface of the user device.

13. The method of claim 11, wherein identifying the goal context for the industry-specific problem by analyzing the semantic meaning and the user intent of the received input data using the AI model comprises:
preprocessing, by the processor, the received input data by standardizing queries, tokenizing the input data, and extracting user-specified constraints;
generating, by the processor, problem representation data for the preprocessed input data using an embedding model, wherein the problem representation data comprises multi-dimensional vectors;
generating, by the processor, standardized goal representation data for the preprocessed input data by performing at least one of an entity recognition, a user intent detection, and data structuring of the generated problem representation data using an AI-based semantic analyzer model;
determining, by the processor, the semantic meaning and the user intent of the received input data based on the generated standardized goal representation data using the AI model; and
outputting, by the processor, the goal context as a structured representation based on the determined semantic meaning and the user intent using the AI model, wherein the goal context comprises key entities, relationships, and inferred objectives corresponding to the received input data.

14. The method of claim 11, wherein selecting the industry-specific process workflow corresponding to the industry-specific problem based on the identified goal context, comprises:
mapping, by the processor, the identified goal context to a plurality of predefined industry-specific process workflows stored in a workflow library;
evaluating, by the processor, the plurality of predefined industry-specific process workflows with the user goals, the user requirements, and the user preferences extracted from the received input data based on the mapping;
ranking, by the processor, the plurality of predefined industry-specific process workflows using a similarity score between goal context embedding and process workflow embeddings; and
selecting, by the processor, the industry-specific process workflow comprising the similarity score exceeding a predefined threshold value based on the ranking, wherein the selected industry-specific process workflow defines a sequence of domain-specific tasks, decision nodes, and evaluation criteria associated with the industry-specific process workflow.

15. The method of claim 11, wherein retrieving the at least one of the agentic context, the historical intelligence data, the group dynamics data for the agent compatibility, the appropriate agent character data, and the historical user feedback data corresponding to the selected industry-specific workflow from the agentic data sources and the non-agentic data sources comprises:
generating, by the processor, a plurality of normalized retrieval queries from the identified goal context, wherein the normalized retrieval queries comprise canonicalized user goals, extracted constraints and metadata;
selecting, by the processor, at least one target source category comprising the agentic data sources and the non-agentic data sources based on the plurality of normalized retrieval queries;
executing, by the processor, a staged hybrid retrieval pipeline for the selected at least one target source category using the plurality of normalized retrieval queries, wherein the staged pipeline comprises at least one of a vector retrieval to obtain dense candidate chunk identifiers, lexical retrieval to obtain lexical candidate chunk identifiers;
generating, by the processor, a final set of context chunks by merging the dense candidate chunk identifiers and the lexical candidate chunk identifiers;
ranking, by the processor, the generated final set of context chunks using a composite scoring function value, wherein the composite scoring function value combines a cross-encoder score, a vector cosine similarity score, a lexical score, a freshness bonus score and a license penalty score based on a configurable weighted model;
annotating, by the processor, the generated final ranked set of context chunks based on the re-ranking by applying at least one of a trust filter, a licensing filter, a freshness filter, and an Optical Character Recognition (OCR)-confidence filter;
generating, by the processor, an aggregated retrieval result comprising at least one of the agentic context object, the historical intelligence data, the group dynamics data for agent compatibility, the appropriate agent character data and the historical user feedback data based on the annotation;
computing, by the processor, a relevance score, and a confidence score for each element of the aggregated retrieval result by merging retrieval final scores, embedding similarity measures between a problem embedding and agent skill vectors, and semantic-parser certainty scores; and
outputting, by the processor, the at least one of the agentic context, the historical intelligence data, the group dynamics data for the agent compatibility, the appropriate agent character data, and the historical user feedback data corresponding to the selected industry-specific workflow based on the computed relevance score and the confidence score.

16. The method of claim 11, wherein selecting the plurality of AI agents and the agent compatibility rules to execute the user goals based on the retrieved at least one of the agentic context, the historical intelligence data, the group dynamics data for agent compatibility, the appropriate agent character data, and the historical user feedback data comprises:
retrieving, by the processor, candidate AI agent records from a plurality of agent registries and external agent sources based on the retrieved at least one of the agentic context, the historical intelligence data, the group dynamics data for agent compatibility, the appropriate agent character data, and the historical user feedback data;
computing, by the processor, a candidate match score for each of the retrieved candidate AI agent by combining a similarity measure between a problem embedding representing the goal context and a skill vector of the candidate AI agent, a historical-performance score derived from the historical intelligence data, a compatibility score derived from the group dynamics data and the agent character data, and a feedback score derived from the historical user feedback data;
applying, by the processor, the agent compatibility rules to the candidate AI agent, wherein the agent compatibility rules comprise parameters for diversity, the emotional quotient, the educational background data, the generational background data, socio-economic parameters, a trust level, and permissible tool-access;
applying, by the processor, at least one selection policy to rank remaining candidate AI agents based on candidate match scores and compatibility assessments, wherein the at least one selection policy comprises a round-robin policy, a weighted domain relevance policy, a similarity-based matching policy, and a Large Language Model (LLM)-based ranking;
selecting, by the processor, at least one primary agent as a leader agent based on a historical effectiveness and a domain relevance, the plurality of secondary agents based on complementary skills and compatibility scores with the at least one primary agent, and the plurality of user agent profiles based on ranking positions and the at least one selection policy;
assigning, by the processor, a role and corresponding agent-specific execution parameters to each of the selected at least one primary agent and the plurality of secondary agents, wherein the agent-specific execution parameters comprise task responsibilities, persona prompts, access scopes, memory scope references and trust and tool-access tokens;
validating, by the processor, the selected at least one primary agent and the plurality of secondary agents with at least one of an availability level, a trust level, performance thresholds and based on real-time user feedback data;
iteratively adjusting, by the processor, the selected at least one primary agent and the plurality of secondary agents by modifying the agent compatibility rules until the selected at least one primary agent and the plurality of secondary agents satisfy a selection termination condition; and
outputting, by the processor, the selected plurality of AI agents and the assigned agent compatibility rules based on the adjusted at least one primary agent, the plurality of secondary agents and the modified agent compatibility rules.

17. The method of claim 11, wherein generating the agentic process workflow for the industry-specific problem based on the assigned agent compatibility rules and the plurality of AI agents comprise:
classifying, by the processor, the selected industry-specific process workflow into a plurality of sequential and parallel tasks required to address the industry-specific problem;
allocating, by the processor, each task to at least one of the selected plurality of AI agents based on the assigned agent compatibility rules, role assignments, skill vectors, trust levels, tool-access rights, and agent performance history;
generating, by the processor, a Directed Acyclic Graph (DAG) structure by defining execution dependencies between the tasks, wherein the DAG structure comprises task ordering, data flows, and decision points;
embedding, by the processor, the assigned agent compatibility rules into the agentic process workflow based on the diversity, the emotional quotient, the educational background data, the generational background data, and the socio-economic parameters; and
generating, by the processor, execution metadata for the agentic process workflow, wherein the execution metadata comprises task identifiers, assigned agent identifiers, input and output parameters, and evaluation criteria.

18. The method of claim 11, wherein generating the at least one candidate solution for the industry-specific problem by executing the generated agentic process workflow using the selected plurality of AI agents in the virtual environment using the Gen AI model comprises:
instantiating, by the processor, the selected plurality of AI agents within the virtual environment configured with shared context memory and communication channels;
executing, by the processor, the plurality of sequential tasks defined in the agentic process workflow by invoking the Gen AI model to simulate outputs of the selected plurality of AI agents, wherein the execution comprises at least one of conversation turns, tool invocations, multimodal content generation, and iterative refinement;
determining, by the processor, intermediate outputs, inter-agent communications, and user-agent profile feedback during the execution of the plurality of sequential tasks based on the agentic process workflow;
evaluating, by the processor, each intermediate output and a final output based on a predefined criteria, wherein the predefined criteria comprises at least one of an accuracy level, a creativity level, a feasibility level and a compliance level with the user goals and constraints;
iteratively refining, by the processor, the intermediate outputs by re-executing portions of the agentic process workflow based on evaluation scores failing to meet defined thresholds; and
generating, by the processor, at least one candidate solution based on the intermediate outputs and the evaluated final output from the selected plurality of AI agents.

19. The method of claim 11, wherein the agentic process workflow comprises a dynamically generated execution plan mapping the predefined sequence of tasks of the industry-specific process workflow to the selected plurality of AI agents based on the assigned agent compatibility rules and inter-agent coordination parameters.

20. A non-transitory computer readable medium comprising a processor-executable instructions that cause a processor to:
receive input data corresponding to an industry-specific problem from at least one data source, wherein the input data comprises user goals, user requirements, and user preferences;
identify a goal context for the industry-specific problem by analyzing a semantic meaning and a user intent of the received input data using an Artificial Intelligence (AI) model;
select an industry-specific process workflow corresponding to the industry-specific problem based on the identified goal context, wherein the industry-specific process workflow comprises a predefined sequence of domain-specific tasks and decision nodes derived from workflow templates;
retrieve at least one of an agentic context, historical intelligence data, group dynamics data for agent compatibility, appropriate agent character data, and historical user feedback data corresponding to the selected industry-specific workflow from agentic data sources and non-agentic data sources;
select a plurality of AI agents and agent compatibility rules to execute the user goals based on the retrieved at least one of the agentic context, the historical intelligence data, the group dynamics data for agent compatibility, the appropriate agent character data, and the historical user feedback data, wherein the plurality of AI agents comprise at least one primary agent, a plurality of secondary agents, and associated plurality of user agent profiles;
assign the identified agent compatibility rules to each of the selected plurality of AI agents, wherein the identified agent compatibility rules comprise parameters for diversity, an emotional quotient, an educational background data, a generational background data, and socio-economic parameters;
generate an agentic process workflow for the industry-specific problem based on the assigned identified agent compatibility rules and the plurality of AI agents, wherein the agentic process workflow comprises a plurality of sequential tasks to be performed by each of the plurality of AI agents;
generate at least one candidate solution for the industry-specific problem by executing the generated agentic process workflow using the selected plurality of AI agents in a virtual environment using a Generative Artificial Intelligence (Gen AI) model; and
output the at least one candidate solution, the agentic process workflow and the agent compatibility rules on a user interface of a user device.
